(19) United States
(12) Patent Application Publication
(10) Pub. No.: US 2014/0019230 A1
(43) Pub. Date: Jan. 16, 2014

(54) INFORMATION PROCESSING SYSTEM AND METHOD FOR TRACKING GEOGRAPHICALLY TARGETED ADVERTISEMENTS

(71) Applicant: Cree Lawson, New York, NY (US)

(72) Inventor: Cree Lawson, New York, NY (US)

(73) Assignee: ARRIVALIST CO., New York, NY (US)

(21) Appl. No.: 13/549,141

(22) Filed: Jul. 13, 2012

(51) Int. Cl. G06Q 30/02

(52) U.S. Cl. 705/14.45; 705/14.58

(57) ABSTRACT

A computer-implemented method comprising receiving a first current location associated with a user device, causing to be presented at the user device a first content item associated with a destination location that is different from the first current location, recording the fact that the first content item was presented at the user device, receiving a second current location associated with the user device, determining whether the second current location corresponds to the destination location, responding to a determination that the second current location corresponds to the destination location by causing to be presented at the user device a second content item associated with the destination location, and recording the fact that the second content item was presented at the user device.

### BACKGROUND

1. Technical Field

The present disclosure relates to the placement and tracking of advertisements, and more particularly, to systems and methods for assessing the effectiveness of online advertisements related to a particular geographic location.

2. Background of Related Art

The internet has profoundly changed the manner in which advertisers reach their target audiences. Whereas, prior to online advertising, a target demographic was largely predetermined by the broadcast or print media venue in which an advertisement was presented, online advertisements can be precisely targeted in near real-time based on the browsing habits and preferences of consumers. The ever-increasing use of portable internet devices, such as smart phones and tablet computers, has given advertisers unprecedented access to the preferences and activities of consumers. As a result, revenues in the online advertising industry are expected to exceed $25 billion annually.

Destination marketing has evolved with increased use of the internet. The number of trips booked online by individual travelers has significantly increased while the number of travel agencies in existence has fallen by nearly one-half. As a result, the destination marketing and advertising industry has turned its focus on effectively targeting and tracking online users. An ad impression occurs when a particular ad is presented to a user. An ad conversion occurs is when a user takes affirmative action as a consequence of being exposed to an impression, such as booking a vacation, reserving a rental car, or traveling to a destination location.

While various computer-based methods of tracking online ad conversions have been developed, there exists a continuing need within the destination marketing industry for improved user, advertisement, and conversion tracking of ads relating to destination locations.

### SUMMARY

The present disclosure relates to a system and method for tracking an advertisement impression for a destination location that is presented to a user at a first time and at a first location, and tracking subsequent activity of the user to ascertain whether the user traveled to the destination that was the subject of the advertisement. If the system concludes that the user did travel to the destination location, a conversion is deemed to have occurred and the appropriate parties receive credit for the conversion. Appropriate parties may include, without limitation, the advertiser, an ad network participant, the advertisement hosting server, the owner of a web page in which the advertisement was placed, the user, the destination location, and so forth.

In some embodiments, once the user has reached a destination location, one or more additional ads may be presented to the user that relate to the destination location. For example, if a user in New York is first exposed to a primary ad for Orlando, and subsequently travels to Orlando, the disclosed system will credit the primary advertiser, publisher, or other appropriate party with a conversion. Optionally, once it is established that the user is in the destination location, the user may be exposed to secondary “in-market” advertisements relating to the destination location. If the user interacts with these secondary advertisements (e.g., clicks on the ad, redeems a coupon provided via the ad, makes a purchase, etc.), the primary advertiser and/or the secondary advertiser receive credit. In another scenario, where the user is not exposed to a secondary advertisement but interacts with an in-market participant, the primary advertiser receives credit. Continuing with the above example, a New York user travels to Orlando, and while in Orlando, eats at Joe's Restaurant that is an advertiser or ad exchange (“media-buying”) participant. In this instance, the primary advertiser receives credit for the conversion, as it may be understood that, but for the primary advertisement, the user would not have eaten at Joe's Restaurant in Orlando.

In another aspect of the present disclosure, a computer-implemented method is provided, comprising receiving a first current location associated with a user device, causing to be presented at the user device a first content item associated with a destination location that is different from the first current location, recording the fact that the first content item was presented at the user device, receiving a second current location associated with the user device, determining whether the second current location corresponds to the destination location, responding to a determination that the second current location corresponds to the destination location by causing to be presented at the user device a second content item associated with the destination location, and recording the fact that the second content item was presented at the user device.

In some embodiments, the disclosed computer-implemented method includes recording the first current location associated with the user device.

In some embodiments, the disclosed computer-implemented method includes responding to a determination that the second current location corresponds to the destination location by recording the fact that the user has moved from the first current location to the destination location.

In some embodiments of the disclosed computer-implemented method, a content item is selected from the group consisting of an advertisement, an article, a web page, a video clip, and an audio clip.

In some embodiments of the disclosed computer-implemented method, the first content item is associated with a first content provider.

In some embodiments of the disclosed computer-implemented method, causing to be presented at the user device a first content item includes causing the first content provider to receive a credit.

In some embodiments of the disclosed computer-implemented method, responding to a determination that the second current location corresponds to the destination location causes the first content provider to receive a credit.

In some embodiments of the disclosed computer-implemented method, causing to be presented at the user device a first content item causes a user associated with the user device to receive a credit.

In some embodiments of the disclosed computer-implemented method, responding to a determination that the second current location corresponds to the destination location causes the user causes a user associated with the user device to receive a credit.

In some embodiments of the disclosed computer-implemented method, a location is selected from the group consisting of one or more predefined geographic areas, one or more predefined commercial areas, and one or more predefined virtual areas.

In another aspect of the present disclosure, an information processing system is presented that includes a location receiving unit configured to receive a location of a user device, a content selection unit configured to select an impression content based at least in part upon the location of the user device, an impression delivery unit configured to deliver an impression to the user device for presentation to a user of the user device, an impression recording unit configured to record the fact that the impression was presented to the user, a location recording unit configured to record the location of the user device, and a determination unit configured to determine whether the location of the user device has changed.

In some embodiments, the impression delivery unit is further configured to deliver an exclusion pixel to the user device. In some embodiments, the information processing system includes a location determining unit associated with the user device and configured to determine a location of the user device and convey the location of the user device to the location receiving unit.

In some embodiments, the location determining unit determines location by at least one of a global positioning system, internet protocol address geolocation, cellular signal triangulation, or WiFi network geolocation.

In some embodiments, the information processing system includes a determining unit that is configured to determine a distance between a first location of the user device and a second location of the user device.

In another aspect of the present disclosure, an advertisement system for presenting advertisements at a user device is presented. The advertisement system includes a request receiving unit configured to receive at least one of an advertising request and an application unit delivery request from a user device, a location receiving unit configured to receive a location of the user device, a location recording unit in operable communication with the location receiving unit and configured to record the location of the user device, an application unit configured for delivery to the user device, wherein the application unit is configured to receive at least one identifier corresponding to the user of the user device and is further configured to convey the location of the user device to the location receiving unit, and an application delivery unit in operable communication with the request receiving unit and configured to deliver to the user device the application unit in response to the request receiving unit receiving an application delivery request from a user device.

In some embodiments, the application unit is further configured to receive a user input, and in response thereto, convey to the request receiving unit an advertising request.

In some embodiments, the request receiving unit is further configured to receive a user identifier.

In some embodiments, the advertisement system includes an advertising delivery unit configured to deliver an advertisement to the application unit. In some embodiments, the application unit is configured to receive an advertisement.

In another aspect, the present disclosure relates to an information processing system and method that uses a geographically distributed signaling system to notify advertisers of a particular user's proximity to a product or service about which the user has been previously informed via an advertisement. In some embodiments, the disclosed information processing system and method associates a user's on-line activity, such as the user's on-line advertisement viewing activity with a computer, to the user's off-line activity, such as the user's arrival at a destination after the advertisement viewing. In some embodiments, a user device, such as a smart phone, is employed to determine the user's geographic location. In some embodiments, one or more data items, such as a cookie, may be utilized to record and track user activity.

The disclosed information processing system includes one or more data processing units that are employed to receive a request from a user or user device, respond to a user request, and to record user activity. In some embodiments, an information processing system in accordance with the present disclosure include an impression recording unit that is configured to create a profile cookie when a user views an advertisement, and assigns a user identifier (“user_id”) to the device from which the advertisement was viewed. For example, the user id may assigned to an internet protocol (IP) address associated with a user device; a hardware identifier, such as a media access control (MAC) address of a network interface or other hardware serial number associated with a user device; and/or a software identifier such as an email address or other identifier uniquely associated with a particular user. For example, and without limitation, the user id may be assigned to a user through a login procedure when the user authenticates with a user name and password. The impression recording unit then assigns the user id to the user computer based on the logged in user identifier.

In some embodiments, an information processing system in accordance with the present disclosure include a location receiving unit that is configured to receive indicia corresponding to a geographic location of a user device.

In some embodiments, an information processing system in accordance with the present disclosure includes a content selection unit that is configured to receive a user id, an ad id, and/or a location id, and in response select an appropriate content item (“ad”) based upon one or more predetermined criteria.

In some embodiments, an information processing system in accordance with the present disclosure includes an impression delivery unit configured to deliver to a user device a content item. The impression delivery unit may additionally be configured to incorporate one more identifiers, some or all of which may be unique identifiers; one or more data elements; and/or executable instructions into a content item. In these embodiments, the impression device assembles a unique content item consisting of a base advertisement having text, image, sound, etc., that are readily perceivable by a human user, with one or tracking elements that are not readily perceived by a user, but are available to the information processing system. In some embodiments, the identifier may include a graphic image consisting of a single pixel, sometimes referred to as an “inclusion pixel” or “exclusion pixel” as described hereinbelow, and may be transparent, clear, or have the same color as a background so as to be invisible to the user. The URL associated with the pixel causes a cookie to be written to or read from the user device when the pixel is served to a user device, as will be understood by the skilled artisan.

In some embodiments, the user cookie stores indicia of one or more user-exhibited online behaviors, including one or more advertisement impression identifiers (“ad ids”) that indicate advertisements viewed by the user. The user cookie initially has a user id and an ad id for the initial advertisement viewed by the user and later may include one or more other ad ids for other advertisements viewed by the user.

In another aspect of an information processing system in accordance with the present disclosure, when the impression recording unit stores the user cookie to the user computer, the impression recording unit also records the user cookie information, including the user id and one or more ad ids, to a user profile or user record store. The impression recording unit additionally or alternatively creates a user profile, assigns a user id to the user profile, stores the user profile with the user id on the impression recording unit, and then creates a user cookie or other tracking information on the user's computer. The user cookie initially has the user id and an ad id for the initially viewed advertisement and later may include one or more other ad ids for other advertisements viewed by the user.

Additionally or alternatively, the user creates a user profile through one or more options prior to viewing advertisements, such as via a web page. In this instance, the impression recording unit assigns a user id to the user profile, stores the user profile with the user id on the impression recording unit, and creates a user cookie or other tracking information on the user's computer. The profile cookie initially has the user id and later may include one or more ad ids, locations ids, and/or destination location ids of advertisements viewed by the user.

In some embodiments, the impression recording unit stores the user id and causes the user id and other cookie information to be stored in the user cookie. The impression recording unit then obtains the cookie information from the user cookie at one or more points in time, such as when the impression recording unit receives communications from the user device or otherwise attempts to correlate data. In these embodiment, the impression recording unit stored a backup of information stored in the user cookie in case the user cookie is deleted, or otherwise lost.

In some embodiments, the impression recording unit stores the user cookie on a shared storage facility, e.g., distributed or cloud storage. The impression recording unit stores the user id, and all other cookie information is stored in shared storage. The impression recording unit then obtains the cookie information from shared storage at one or more points in time, such as when the impression recording unit receives communications from the user device, when the user logs into the shared storage facility, or when the impression recording unit correlates user id and other cookie information. Additionally or alternatively, the user cookie is stored on the user device, and the cookie information is copied to the shared storage when the user logs into a shared storage facility.

In one aspect, the disclosed information processing system embeds one or more pixels into an ad impression, which my include without limitation, a banner advertisement promoting a particular advertiser's service or product. When the banner is viewed, the impression recording unit creates the user cookie on the user's computer with an ad id for the advertisement and a user id associated with the user device (or user). A user profile also is created at the impression recording unit with the user id and the ad id. When the user clicks an advertisement, a web page is generated to the user's computer from which the user can download the app or cause the app to be downloaded to the user device.

In another aspect, the user cookie is not created until the user clicks on an advertisement. When the user clicks on the advertisement, the user cookie with the ad id and user id is created on the user's computer, and a user profile is created at the impression recording unit with the user id and the ad id. A web page is generated and delivered to the user's computer from which the user can download the app or cause the app to be downloaded to the user device.

At the web page, the user enters his or her email address. An email or other communication is sent to the user at the email address. The user clicks on a confirmation link in the email or other communication from the user's computer. An app id is then generated for the app, and the app can be downloaded to the user device. The app id may be loaded to the user device with the downloaded app. For example, the app id may be a randomly generated identifier not directly linked to any ad id. The profile cookie and server profile are updated with the app id corresponding to the downloaded app. In some embodiments, the user cookie and/or server profile are updated with the email address. A link to the app is then sent to the user device to download the application.

In another embodiment, the user downloads the app to the user device directly, such as without clicking on an advertisement. For example, the user navigates to the notification system web site and downloads an app. When the user opens the app, the app displays a screen requesting the user to confirm its email address. The user enters its email address, and a confirmation email is sent to the email address. The user clicks on a confirmation link in the email from the user's computer. An app id is then generated for the app, and the app then can be downloaded to the user device. The user cookie and user profile are updated with the app id corresponding to the downloaded app. Optionally, the user cookie and/or user profile are updated with the email address.

When the app is downloaded to the user device after the user clicks the confirmation link in the email, the impression recording unit transmits a communication with the user id to the app on the user device. The app on the user device stores the user id on the user device.

In another aspect, the disclosed information processing system is in operative communication with a location determination unit provided by a user device. In some embodiments, the location determination unit is configured to detect when the user device is located within a proximity to a destination location (such as at or within a geographic location). In these embodiments, location determination unit receives a signal from a signal transmitting device (the “beacon”) that includes an identifier of the device (a “beacon id”). The location determining unit receives the beacon id and conveys the beacon id to the information processing system. An application program (“app”) may be utilized to receive the beacon id, and/or a transient executable program (e.g., Javascript) may be used. The app id, beacon id, and user id are received by the impression recording unit. In some embodiments, the location determination unit employs a global positioning system receiver that operates in accordance with any current or future global positioning system standard, including without limitation, GPS (United States), GLONASS (Russia), Galileo (European Union), and Compass (China). In some embodiments, the location determination unit employs a cellular radiotelephone transceiver that is configured to derive the geographic location thereof from cellular communication signals using triangulation or other methods that will be familiar to the skilled artisan. In some embodiments, the location determination unit employs a wireless networking transceiver (e.g., “WiFi”) that is configured to determine the geographic location thereof from the identity of a wireless network operating within the reception area of the location determination unit. In these embodiments, a database that correlates a unique network identifier of a wireless network to the physical location of one or more transceivers comprising the network. For example, the MAC address of the wireless access point may be used as the unique network identifier.

The impression recording unit uses the profile id when correlating data from the user device and data from the profile cookie or server profile for a user. The profile id, app id, and beacon id (the “app data”) are received from the app on the user device at the impression recording unit. The profile cookie or server profile has the profile id, ad ids, and app id. For example, the beacon id identifies the destination visited by the user, the profile id identifies the user that viewed the one or more advertisements, and the ad ids identify the one or more advertisements viewed by the user.

If necessary, the impression recording unit requests the cookie information from the shared storage or profile cookie on the user's computer. Alternately, the cookie information is already stored on the impression recording unit in the server profile.

The impression recording unit correlates the app data with the cookie information through the profile id. Thus, the impression recording unit identifies the profile id from the app data and then searches the cookie information for the same profile id. Once a match is identified, the impression recording unit compares the beacon id from the app data with the ad ids from the cookie information to locate any one or more advertisements that were directed to the destination that corresponds to the beacon id. The impression recording unit then transmits the located advertisements to a reporting server. Thus, the impression recording unit can directly link one or more advertisements viewed by the user to the destination and attribute an arrival at the destination to the one or more advertisements to which the user was exposed.

In one aspect, the profile cookie includes the time the advertisement was viewed by the user, in addition to the ad id. Thus, the recoding server can correlate the time and date the user arrived at the destination with the beacon to the time(s) and date(s) the user viewed the one or more advertisements directed to the destination associated with the beacon.

In another aspect, the impression recording unit has advertising data associated with each displayed ad, including when the ad was displayed and on which website the ad was displayed. In this aspect, the impression recording unit correlates the time and date the user arrived at the beacon to the time(s) and date(s) the user viewed the one or more advertisements directed to the destination associated with the beacon and the website(s) from which the advertisement was viewed.

While the app id identifies the app downloaded by the user, the app id is not used in some embodiments to correlate data since it is a randomly generated number.

Embodiments of the present disclosure may be described herein in terms of functional block components, code listings, optional selections, page displays, and various processing steps. It should be appreciated that such functional blocks may be realized by any number of hardware and/or software components configured to perform the specified functions. For example, may employ various integrated circuit components, e.g., memory elements, processing elements, logic elements, look-up tables, and the like, which may carry out a variety of functions under the control of one or more microprocessors or other control devices.

Similarly, the software elements of embodiments of the present disclosure may be implemented with any programming or scripting environment such as C, C++, C#, Java, COBOL, assembler, PERL, Python, PHP, Ruby on Rails, or the like, with the various algorithms being implemented with any combination of data structures, objects, processes, routines or other programming elements. The object code created may be executed by any computer having an internet web browser, on a variety of operating systems including Windows, Macintosh, and/or Linux and variations thereof.

Further, it should be noted that embodiments of the present disclosure may employ any number of conventional techniques for data transmission, signaling, data processing, network control, and the like.

It should be appreciated that the particular implementations shown and described herein are illustrative of the invention and its best mode and are not intended to otherwise limit the scope of the present disclosure in any way. Examples are presented herein which may include sample data items (e.g., names, dates, etc.) which are intended as examples and are not to be construed as limiting. Indeed, for the sake of brevity, conventional data networking, application development and other functional aspects of the systems (and components of the individual operating components of the systems) may not be described in detail herein. Furthermore, the connecting lines shown in the various figures contained herein are intended to represent example functional relationships and/or physical or virtual couplings between the various elements. It should be noted that many alternative or additional functional relationships or physical or virtual connections may be present in a practical electronic data communications system.

As will be appreciated by one of ordinary skill in the art, embodiments of the present disclosure may be practiced as a method, a data processing system, a device for data processing, and/or a computer program product. Accordingly, embodiments of the present disclosure may take the form of an entirely software embodiment, an entirely hardware embodiment, or an embodiment combining aspects of both software and hardware. Furthermore, embodiments of the present disclosure may take the form of a computer program product on a computer-readable storage medium having computer-readable program code means embodied in the storage medium. Any suitable computer-readable storage medium now or in the future known may be utilized, including hard disks, CD-ROM, DVD-ROM, optical storage devices, magnetic storage devices, semiconductor storage devices (e.g., USB thumb drives, solid state drives) and/or the like.

Embodiments of the present disclosure are described below with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified functions or steps, or suitable combinations of special purpose hardware and computer instructions.

One skilled in the art will also appreciate that, for security reasons, any databases, systems, or components of embodiments of the present disclosure may consist of any combination of databases or components at a single location or at multiple locations, wherein each database or system includes any of various suitable security features, such as firewalls, access codes, encryption, de-encryption, compression, decompression, and/or the like.

The scope of the invention should be determined by the appended claims and their legal equivalents, rather than by the examples given herein. For example, the steps recited in any method claims may be executed in any order and are not limited to the order presented in the claims. Moreover, no element is essential to the practice of the invention unless specifically described herein as “critical” or “essential.”

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is schematic block diagram of an embodiment of an information processing system in accordance with the present disclosure;

FIG. 2 illustrates request processing in accordance with an embodiment of the present disclosure;

FIG. 3 illustrates a method of operating an information processing system in accordance with an embodiment of the present disclosure;

FIG. 4 illustrates another method of operating an information processing system in accordance with another embodiment of the present disclosure;

FIG. 5 illustrates yet another method of operating an information processing system in accordance with yet another embodiment of the present disclosure; and

FIG. 6 illustrates still another method of operating an information processing system in accordance with still another embodiment of the present disclosure.

### DETAILED DESCRIPTION

Particular embodiments of the present disclosure are described hereinbelow with reference to the accompanying drawings; however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure. In the discussion contained herein, the terms user interface element and/or button are understood to be non-limiting, and include such other user interface elements as, without limitation, a hyperlink, clickable image, and the like. Terms referencing any action understood to actuate, accept, or affirmatively acknowledge a user interface element may include without limitation a click, a touch, a tap, a swipe, a double-click, and the like. A user device may be any device associated with an individual user, e.g., a smart phone, desktop computer, notebook, tablet, etc. An individual user may be associated with one or more user devices. In some embodiments, a user may authenticate to the device by providing credentials, such as a username and password. In these embodiments, any device may assume the role of the user device associated with a particular authenticated user.

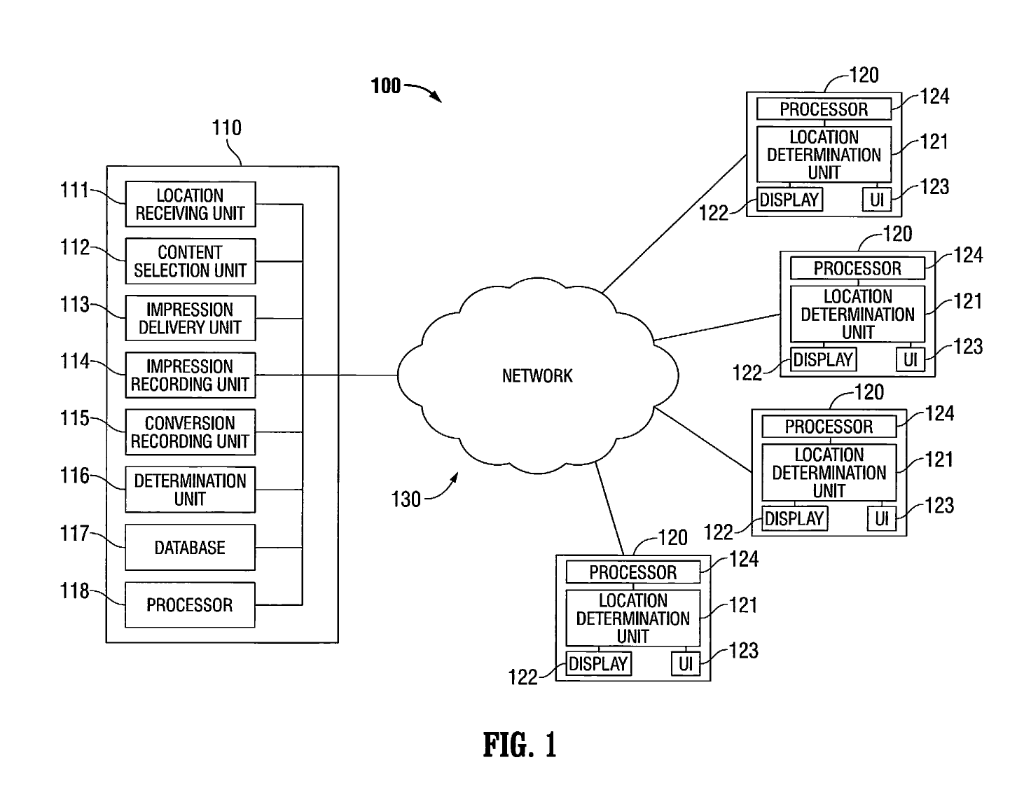

FIG. 1 illustrates a schematic block diagram of an embodiment of an information processing system 100 in accordance with the present disclosure. The system 100 includes an information processing unit 110 in operative communication with one or more user devices 120 via a communications network 130. Information processing unit 110 may include one or more computers, processors, servers, storage devices, and/or virtual machines, and/or combinations thereof. Network 130 may include any communication infrastructure configured to communicate digital information among and between devices connected thereto, such as, without limitation, the public internet, cellular communications networks (e.g., CDMA, GSM, LTE, etc.), private wireless networks (e.g., 802.11 WiFi), private local area networks, and/or combinations thereof.

Information processing unit 110 includes location receiving unit 111 that is configured to receive a location from user device 120. User device 120 includes location determination unit 121 that is configured to determine a geographic location at which user device is presently situated and to facilitate the conveyance thereof to location receiving unit 111. Location determining unit 121 may determine location using one or more location determining technologies now or in the future known, including without limitation, a global positioning system that utilizes signals received from satellites, cellular triangulation based upon the relationship of signals received from in-range cellular towers, WiFi network identification based upon a relationship between predefined wireless network identifiers (e.g., one or more of SSID, MAC addresses, and the like) and a known location of the identified network; IP geolocation based upon a predetermined relationship between IP address and location, and/or a location beacon broadcast within a geographic region (e.g., an acoustic or electromagnetic signal broadcast locally within a store, a mall, airport, hotel, restaurant, amusement park, cruise ship, etc.) that identifies the location corresponding to the area in which the beacon may be received. Location determining unit 121 may in some embodiments be configured to determine an accuracy measure (e.g., location is accurate to within 10 meters, within 50 meters, and so forth) and optionally to convey the accuracy measure in addition or alternatively to the location.

User device 120 includes a display 122 for the presentation of information, visual images, and audible messages to the user. User device 120 additionally includes a user interface 123 that may include any suitable form of user interface elements designed to receive from, and convey information to, a user, including without limitation physical controls such as one or more buttons, sliders, wheels, knobs, touchscreens, voice recognition devices, and/or “soft” controls such as buttons, widgets, dialog boxes, text entry fields, and the like, that are rendered as part of a graphical user interface presented on display 122.

User device 120 includes a processor 124 in operable communication with at least one of the location determination unit 121, display 122, and/or the user interface 123, and configured to execute a set of programmable instructions for performing one or more of the processes and/or methods described herein.

Information processing unit 110 includes a content selection unit 112 that is configured to receive a user location from location receiving device 111 and select content, e.g., an advertisement, for presentation to the user of the user device 120. Content selection unit 112 may rely upon one or more additional criteria in addition to the user location when selecting content for display. For example, and without limitation, any one or combination of user demographics (age, gender, residence address, income, ethnicity, etc.), browsing history, purchasing history, prior vacation bookings, user preferences, target destinations of previously-presented ad impressions, and so forth, may be taken into consideration when selecting content for presentation to the user. In some embodiments, the content is selected in accordance with one or more location-based rules that ensure that a destination location (dest_loc) corresponding to the selected content is within, at least, or no more than a desired geographical distance from the user's present location (e.g., as received from location receiving unit 111). In some embodiments, the content selection unit 112 may take into account the location of one or more of an advertiser's physical locations, such that the selected content corresponds to a physical location that has been the subject of a previously-selected content item. For example, where a user that previously has been presented with an advertisement for Orlando, the content selection unit may select an advertisement for a national restaurant chain that has a restaurant situated in Orlando.

Information processing unit 110 includes an impression delivery unit 113 that is in operative communication with content selection unit 112 and configured to receive the selected content from content selection unit 112 and deliver said content to the user device 120 via network 130. In some embodiments, impression delivery unit includes a web server (Apache, IIS, and the like) or other software designed to deliver content to a user device. In some embodiments, impression delivery unit 113 is in operative communication with impression recording unit 114.

Information processing unit 110 includes an impression recording unit 114 that is in operable communication with at least one of the content selection unit 112 or the impression delivery unit 113 and configured to record the fact that an impression was presented to a user. When an impression is delivered to the user, one or more delivery parameters relating to the impression delivery are recorded by impression recording unit 114. In some embodiments, such parameters may include one or any combination of an impression identifier (ad_id), a timestamp (ad_timestamp), a user identifier identifying the user to whom the impression was delivered (user_id, profile_id), the location of the user at the time the impression was delivered (loc_id), and/or a destination location corresponding to the impression (dest_loc). In some embodiments, when a location is visited by the user, one or more location parameters relating to the impression delivery corresponding to the location are recorded by impression recording unit 114. In some embodiments, such parameters may include one or any combination of an arrival timestamp, a departure timestamp, and/or whether a location corresponds to a previously-presented ad impression.

Information processing unit 110 includes a conversion recording unit 115 that is in operable communication with location receiving unit 111, impression recording unit 114 and/or determination unit 116 and configured to make and/or retrieve a record of a conversion of an advertisement. In some embodiments, conversion recording unit 115 is in operative communication with either or both of the impression delivery unit 113 and/or impression recording unit 114. When a conversion is detected, conversion recording unit 115 is notified and makes a recording of this fact. Additionally or alternatively, conversion recording unit may be configured to apply a conversion credit to the appropriate party.

Information processing unit 110 includes a determination unit 116 that is configured to determine whether the location of the user device has changed. In some embodiments, determination unit 116 is in operable communication with one of, or any combination of, location receiving unit 111, content selection unit 112, impression delivery unit 113, impression recording unit 114 and/or conversion recording unit 115. In some embodiments, determination unit 116 is configured to receive a current location of a user device (from, e.g., location receiving unit 111), and/or one or more prior locations of a user device (from, e.g., impression recording unit 114 and/or conversion recording unit 115). When an advertising request is received by information processing unit 110, determination unit 116 receives the current location received by location receiving unit 111 and attempts to identify a prior impression corresponding to the user device 120 from which the advertising request is received by querying, e.g., impression recording unit 114 and/or conversion recording unit 115. If the current location corresponds to a destination location stored with respect to a prior advertising impression, the determination unit 116 communicates this fact to conversion recording unit 115.

Information processing unit 110 may additionally include a database 117 that is configured to store, manage, and retrieve data received, generated, and/or used by one or any combination of the location receiving unit 111, content selection unit 112, impression delivery unit 113, impression recording unit 114, conversion recording unit 115 and/or determination unit 117. In some embodiments database 117 includes a relational database.

Information processing unit 110 includes a processor 118 in operable communication with at least one of the location receiving unit 111, content selection unit 112, impression delivery unit 113, impression recording unit 114, conversion recording unit 115, determination unit 116, and/or the database 117, and configured to execute a set of programmable instructions for performing one or more of the processes and/or methods described herein.

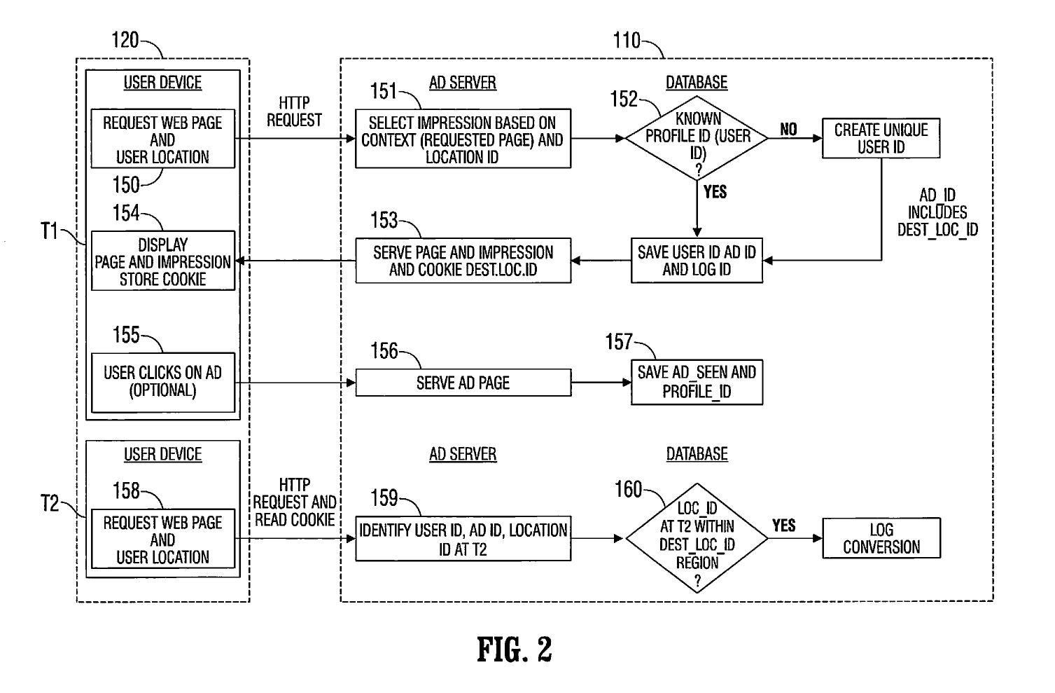

Turning now to FIG. 2, the request processing and method of operating of another embodiment of an information processing system in accordance with present disclosure is shown. In the illustrated embodiment a user device 120 is in communication with an information processing unit (e.g., “ad server”) 110. At a first time T1, a web page request incorporating a the current location loc_id of the user is, in step 150, transmitted from user device 120 to information processing unit 110. Additionally or alternatively, a user identifier (user_id) is included in the request. If no user_id is known, a null user_id or similar indicator may be transmitted to indicate that a new user_id is also requested. Upon receipt of the request, at step 151 the information processing unit 110 selects an impression based at least in part upon the context of the page requested, the user_id, and/or the loc_id. A query is made to the database at step 152 to determine whether an existing user_id record exists for the user. Additionally, the current location id (loc_id) and impression identifier (ad_id) is transmitted to the database. If no user_id exists, or, if a new user_id is to be issued, a new unique user_id is created and assigned to the user. The user_id is stored in association with the ad_id, and the destination location (dest_loc_id) corresponding to the ad_id.

At step 153, the information processing unit 110 formats the requested page, which includes the ad impression corresponding to the ad_id, which is then delivered or “served” to the user device 120. Additionally or optionally, one or more cookies are set at the user device 120 that stores the user_id, ad_id, loc_id, and/or dest_loc_id. In the step 154, the requested page (including the ad impression) is received and displayed at user device 120. In the step 155, the user optionally may interact with the ad impression by, e.g., clicking or tapping a user interface element associated with the ad. In some embodiments, an ad request may be transmitted from the user device 120 to the information processing unit 110 and/or a separate ad server (not explicitly shown). In the step 156, an ad request is received by information processing unit 110, which, in turn, communicates to the database the fact that the ad impression was delivered, and the impression is recorded to the database in the step 157 by storing the corresponding user id, ad_id, loc_id, and dest_loc_id of the impression. In some embodiments, the user need affirmatively interact with an ad impression in order for the fact the ad impression as delivered to be recorded as such. In these embodiments, serving the ad (step 153) or displaying the ad (step 154) is sufficient evidence to record the impression to the database (step 157).

At a later time T2, the user and/or the user device has traveled to a different location. In the step 158, a web page request incorporating the current location loc_id of the user is transmitted from user device 120 to information processing unit 110. Since a user identifier was previously issued to the user and/or the user device 120, the user_id is included in the request. In some embodiments, the ad_id of the prior ad (served in the above step 153) is also transmitted. In some embodiments, the destination dest_loc_id of the prior ad (served in the above step 153) is also transmitted. The request is received at information processing unit 110 and in the step 156 the user identifier (user_id), current location id (loc_id), and, if available, the ad impression id (ad_id) and/or the prior ad destination location identifier (dest_loc_id) are queried to the database. If not available, the ad_id and the dest_loc_id, if any, will be identified by the database, as this information will have been stored for the current user_id. In the step 160, the dest_loc_id for the prior ad is compared to the current location (loc_id) of the user device. If the loc_id falls within the area associated with the dest_loc_id, then a conversion has occurred and is recorded.

In some embodiments, steps 158-160 may be performed at least in part in an iterative fashion, whereby multiple prior ad impressions are individually evaluated to determine which, if any, have a dest_loc_id that corresponds to the user device's current loc_id. In some embodiments, where multiple prior ads' dest_loc_id match the current loc_id, the conversion may be credited to all of the matching prior ads, or some of the prior ads based on secondary selection factors. Such secondary selection factors may include, without limitation, a weighting factor, a predetermined order (pay for play), a round robin (sequential) approach, a first-in-first-out (FIFO) queued approach, or a random approach.

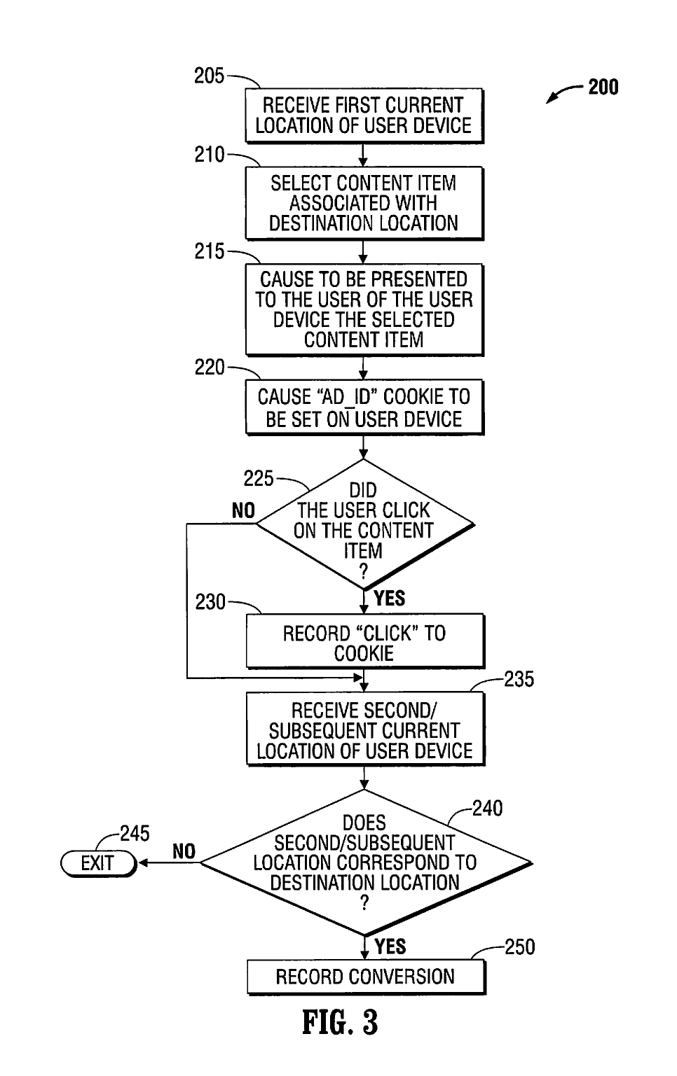

Turning now to FIG. 3, an embodiment of a method 200 of operating an information processing unit wherein in the step 205 a first current location of a user device is received. This first current location may be considered the “origination” location of the user. In the step 210, a content item is selected that is associated with a destination location. An identifier, e.g., dest_loc_id, is associated with the destination location. In some embodiments, specific criteria may be applied to this selection. For example, and without limitation, a minimum distance may be required between the origination location and the destination location; the destination location may need to be located in a different municipality (e.g., different city, state, country). In some embodiments, the destination location may be selected based at least in part on the browsing history, preferences, and/or demographics of the user.

In the step 215 the selected content item is caused to the transmitted to the user device whereupon the content item is presented to the user. In the step 220 the fact of the content item being presented to the user is recorded. In some embodiments, a cookie indicative of the fact the content item was presented to the user may be written to the user device. Additionally or alternatively, the fact the content item was presented to the user may be written to the user device may be recorded at the information processing unit, in a database, or in any suitable storage container. In the step 225, a determination is made whether the user interacted with the impression (e.g., by affirmatively clicking on, tapping, or otherwise actuating a user interface element associated with the impression). If a determination is made that the user did interact with the impression, the fact of this interaction is, in the step 230, recorded to a cookie and/or to a database, as described above.

In the step 235, a second or subsequent location id (loc_id) is received from the user device. In the step 240, a determination is made whether the current loc_id corresponds to the dest_loc_id previously selected in the step 210. If a determination is made that the current loc_id corresponds to the previously-selected dest_loc_id, then a conversion is considered to have occurred and in the step 250, the fact of this conversion is recorded to a cookie and/or to a database, as described above. In the alternative, a determination is made that the current loc_id does not correspond to the previously-selected dest_loc_id, in the step 245, the method exits and may be re-initiated upon receipt of a subsequent loc_id from a user device.

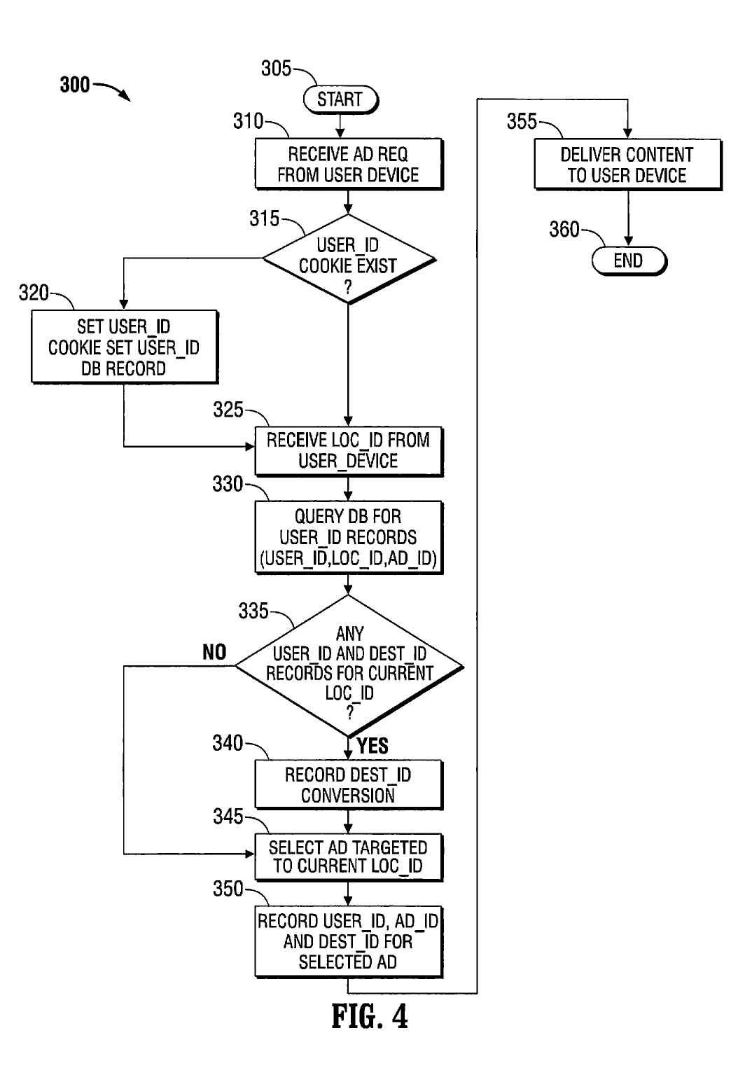

Turning now to FIG. 4, another embodiment of a method 300 of operating an information processing unit is illustrated. The method begin in the step 305 whereupon various routine initializations may be performed, as will be appreciated by the skilled artisan. In the step 310 an ad request containing a user_id is received from a user device. In the step 315 a determination is made whether the user_id is known to exist. If not, in the step 320 the user_id is established and recorded in at least one of a cookie on the user device and a database entry associated with the data processing unit. In the step 320, the current location of the user device is received, e.g., the current loc_id. In the step 330, the database is queried for all recorded impressions of the current user_id in which the destination location id (dest_loc_id) corresponds to the current loc_id received in step 320. In the step 335 the results of the query are evaluated and in the step 340 the retrieved user_id records having a dest_loc_id corresponding to the current loc_id are identified and a conversion is recorded for each.

In the step 345, a new ad (e.g., content item) is selected with respect to the current loc_id, whereby the dest_loc_id of the new ad differs appropriately from the current loc_id, as discussed above. In the step 350, the user id, ad id, and dest_loc_id corresponding to the new ad is recorded in at least one of a cookie stored on the user device, or recorded in the information processing unit. In the step 355 the selected content is delivered to the user device, and the process concludes with the step 360.

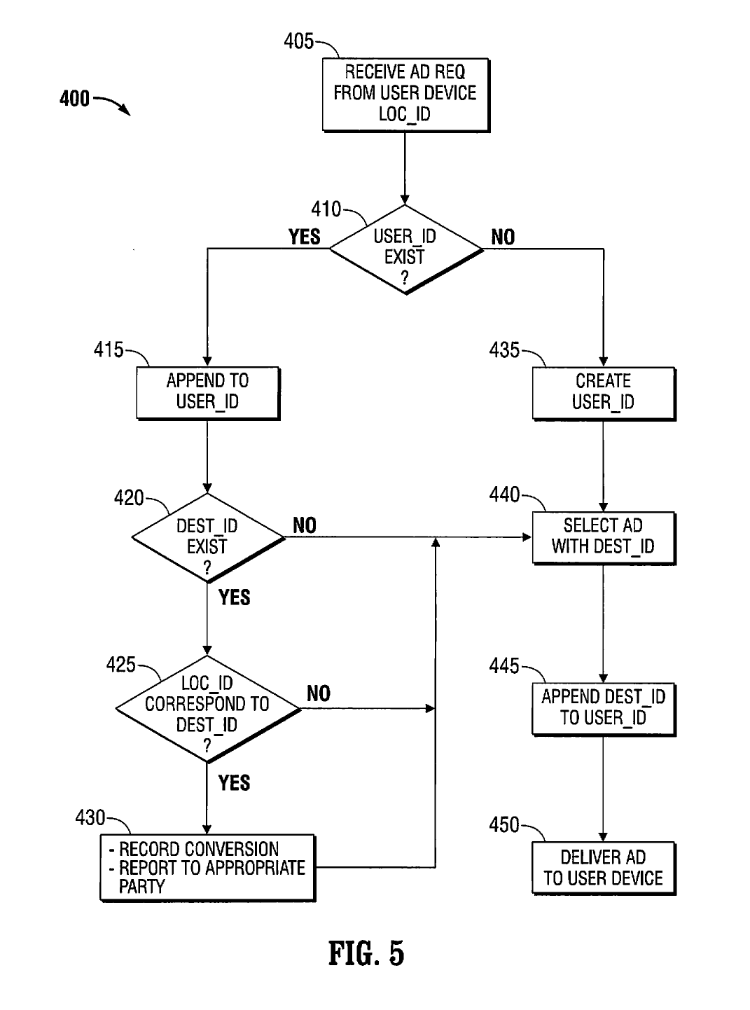

With reference now to FIG. 5, yet another embodiment of a method 400 of operating an information processing unit is illustrated. In the step 405, an ad request containing a user_id and a current loc_id is received. In the step 410 a determination is made whether the user_id is known to the information processing unit (e.g., a null or unknown user_id was received). If a determination is made that the user_id is unknown to the information processing unit, in the step 435 an activity file is established for the user_id at the information processing system, an activity record corresponding to the user_id is established in the user_id activity file, and the process continues with the step 440 described below.

If, in the step 410, it is determined the user_id is known to the information processing system (e.g., an activity file exists), in the step 415 an activity record is appended to the activity file corresponding to the user_id and the activity file is evaluated in the step 420 to determine whether any activity record previously recorded for the current user_id contains a destination location (dest_id). If no such activity record exists, the process continues with the step 440 described below. Conversely, if in the step 420 an activity record(s) is/are found to exist, in the step 425 the identified activity records are evaluated to determine whether any have a destination location identifier (dest_loc_id) that corresponds to the current loc_id. If no activity records have a dest_loc_id that corresponds to the current loc_id, the process continues with the step 440 described below. However, if one or more activity records do have a dest_loc_id that corresponds to the current loc_id, then in the step 430 a conversion is recorded for each of the activity records having dest_loc_id that corresponds to the current loc_id, and additionally or alternatively, notice of and/or credit for the conversion is issued to the appropriate party and the process continues with the step 440, wherein a new ad is selected for the current loc_id in accordance with the principles described hereinabove. In the step 445, a new activity record is appended to the activity file corresponding to the user_id that includes one or more of the user_id, the current loc_id (e.g., the location at which the ad was delivered), the dest_loc_id (e.g., the destination location to which the ad refers), and/or a timestamp, and in the step 450 the method concludes wherein the selected ad is delivered to the user device.

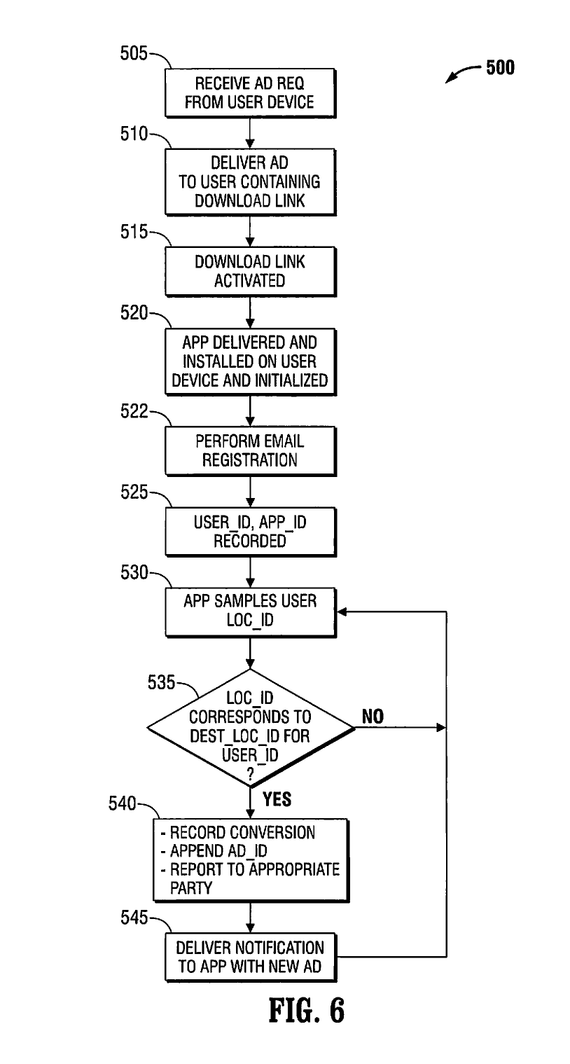

Referring now to FIG. 6, still another embodiment of a method 500 of operating an information processing unit is illustrated. In this embodiment, in the step 505 an ad request is received from a user device and, in the step 510, the ad containing a download link is delivered to the user device. In some embodiments, the download link may be explicitly presented within the ad impression, e.g., a “download” user interface element configured to enable the user to affirmatively initiate a download by activating the download link. In some embodiments, the download link may be implicitly included within the ad impression such that the download link is activated without a user's affirmative selection, e.g., an automatic download, a background download, and/or a download that initiates upon any user interaction with the ad impression. In the step 515, the download link is activated and in the step 520, a set of executable program instructions (an “app”) is delivered to the user device. In some embodiments, in the step 520 the app is installed, is initialized, and/or is functionally activated on the user device without additional user interaction In the step 522, an email registration is performed wherein a an email containing a confirmation link is caused to be sent to an email address associated with the user and/or user device and in response thereto, the user actuates the confirmation link whereupon a unique application identifier (app_id) is generated and associated with the app. In some embodiments, a user_id may be associated with the app without requiring the confirmation link be delivered to, and/or or actuated by, the user. In the step 525, the user_id corresponding to the user device is recorded, and, if no user_id exists, is created prior to recording.

In the step 530, the activated app is in operative communication with the location determination unit 121 and continuously and/or periodically monitors the location of the user device. In some embodiments, the location of the user device is sampled about once every minute, about once every five minute, about once every hour, about once every six hours, or about once every 24 hours. In some embodiments, the user device location sampling interval is user-definable. In the step 535, the currently-sampled loc_id is compared the to one or more dest_loc_id corresponding to previous ad impressions presented the user id. In some embodiments, the dest_loc_id to which the current loc_id is compared is stored in an activity record, as described hereinabove. In some embodiments, the activity record and/or activity file containing activity records may be stored at an information processing unit, in the user device, in the app, and/or any combination thereof. If, in the step 535 a determination is made that the current loc_id corresponds to a previously-recorded dest_loc_id, a conversion is said to have occurred, and in the step 540 the fact of the conversion is recorded. In the step 545, a new ad is selected and delivered to the app for presentation to the user. In some embodiments, a notification is sent to the app to indicate the current location corresponds to a previously-recorded dest_loc_id.

The described embodiments of the present disclosure are intended to be illustrative rather than restrictive, and are not intended to represent every embodiment of the present disclosure. Further variations of the above-disclosed embodiments and other features and functions, or alternatives thereof, may be made or desirably combined into many other different systems, methods, or applications without departing from the spirit or scope of the disclosure as set forth in the following claims both literally and in equivalents recognized in law.

What is claimed is:

1. A computer-implemented method, comprising:
receiving a first current location associated with a user device;
causing to be presented at the user device a first content item associated with a destination location that is different from the first current location;
recording the fact that the first content item was presented at the user device;
receiving a second current location associated with the user device;
determining whether the second current location corresponds to the destination location;
responding to a determination that the second current location corresponds to the destination location by causing to be presented at the user device a second content item associated with the destination location; and
recording the fact that the second content item was presented at the user device.

2. The computer-implemented method in accordance with claim 1, further comprising recording the first current location associated with the user device.

3. The computer-implemented method in accordance with claim 1, further comprising:
responding to a determination that the second current location corresponds to the destination location by recording the fact that the user has moved from the first current location to the destination location.

4. The computer-implemented method of claim 1, wherein a content item is selected from the group consisting of an advertisement, an article, a web page, a video clip, and an audio clip.

5. The computer-implemented method of claim 1, wherein the first content item is associated with a first content provider.

6. The computer-implemented method of claim 5, wherein causing to be presented at the user device a first content item causes the first content provider to receive a credit.

7. The computer-implemented method of claim 5, wherein responding to a determination that the second current location corresponds to the destination location causes the first content provider to receive a credit.

8. The computer-implemented method of claim 1, wherein causing to be presented at the user device a first content item causes a user associated with the user device to receive a credit.

9. The computer-implemented method of claim 1, wherein responding to a determination that the second current location corresponds to the destination location causes the user causes a user associated with the user device to receive a credit.

10. The computer-implemented method of claim 1, wherein a location selected from the group consisting of one or more predefined geographic areas, one or more predefined commercial areas, and one or more predefined virtual areas.

11. An information processing system, comprising:
a location receiving unit configured to receive a location of a user device;
a content selection unit configured to select an impression content based at least in part upon the location of the user device;
an impression delivery unit configured to deliver an impression to the user device for presentation to a user of the user device;
an impression recording unit configured to record the fact that the impression was presented to the user;
a location recording unit configured to record the location of the user device; and
a determination unit configured to determine whether the location of the user device has changed.

12. The information processing system in accordance with claim 11, wherein the impression delivery unit is further configured to deliver an exclusion pixel to the user device.

13. The information processing system in accordance with claim 11, further comprising:
a location determining unit associated with the user device and configured to determine a location of the user device and convey the location of the user device to the location receiving unit.

14. The information processing system in accordance with claim 13, wherein the location determining unit determines location by at least one of a global positioning system, internet protocol address geolocation, cellular signal triangulation, or wifi network geolocation.

15. The information processing system in accordance with claim 11, wherein the determining unit is further configured to determine the distance between a first location of the user device and a second location of the user device.

16. An advertisement system for presenting advertisements at a user device, comprising:
a request receiving unit configured to receive at least one of an advertising request and an application unit delivery request from a user device;
a location receiving unit configured to receive a location of the user device;
a location recording unit in operable communication with the location receiving unit and configured to record the location of the user device;
an application unit configured for delivery to the user device, wherein the application unit is configured to receive at least one identifier corresponding to the user of the user device and is further configured to convey the location of the user device to the location receiving unit; and
an application delivery unit in operable communication with the request receiving unit and configured to deliver to the user device the application unit in response to the request receiving unit receiving an application delivery request from a user device.

17. The advertisement system in accordance with claim 16, wherein the application unit is further configured to receive a user input, and in response thereto, convey to the request receiving unit an advertising request.

18. The advertisement system in accordance with claim 17, wherein the request receiving unit is further configured to receive a user identifier.

19. The advertisement system in accordance with claim 16, further comprising an advertising delivery unit configured to deliver an advertisement to the application unit.

20. The advertisement system in accordance with claim 16, wherein the application unit is configured to receive an advertisement.
